(19) United States
(12) Patent Application Publication
(10) Pub. No.: US 2024/0009704 A1
(43) Pub. Date: Jan. 11, 2024

(54) Rhinestone Size Sorting System

(71) Applicant: Krystail Cousins, LOS ANGELES, CA (US)

(72) Inventor: Krystail Cousins, LOS ANGELES, CA (US)

(21) Appl. No.: 17/811,587

(22) Filed: Jul. 11, 2022

(51) Int. Cl. B07B 1/02; B07B 1/46; B07B 13/04

(52) U.S. Cl. CPC B07B 1/02; B07B 1/469; B07B 13/04; B07B 2201/04; B07B 2201/02

(57) ABSTRACT

A separator, organizer, sorting system for flat back rhinestone of different sizes and material utilizing a multilevel system of compartments with sieves of different size dimensions. Included but not limited to interlocking and stacking compartments that include but is not limited to grip edges. Using a combination of gravitational downward force from an individual or a motorizes device to sort the flat back rhinestones of different sizes into their designated compartment.

### CROSS REFERENCE TO RELATED APPLICATION

This application claims priority to a prior-filed provisional application Ser. No. 62/633,533 filed on Feb. 21, 2018.

### BACKGROUND

The importance of size separation and organization by sieving cannot be understated. There is not a Current systems and methods for sieving flat back rhinestone. Thus exists a need for a system and method for a hand operated, and/or portable motorized device to separate flat back rhinestone of different material and size that is portable, easy to store, lightweight, as well as accessible enough for anyone to use.

### FIELD OF DISCLOSURE

The overall field of the disclosure relates in general to a system for separating flat back rhinestones, more particularly to a system of a multileveled device included by not limited to interlocking compartments in the form of a hand operated and or motorized sieve to separate different sized and material flat back rhinestones.

### BRIEF DESCRIPTION OF DRAWINGS

The present invention will be described by way of exemplary embodiments, but not limitations, illustrated in the accompanying drawings in which like references denote similar elements, and in which:

FIG. 1 depicts a front perspective view of the rhinestone size sorting system in accordance with the present invention.

FIG. 2 depicts a top view of the compartments of the rhinestone size sorting system.

FIG. 3 depicts a perspective view of a compartment of the rhinestone size sorting system.

FIG. 4-5 depicts a vertical cross-sectional view of line 12 of FIG. 1 of the rhinestone size sorting system

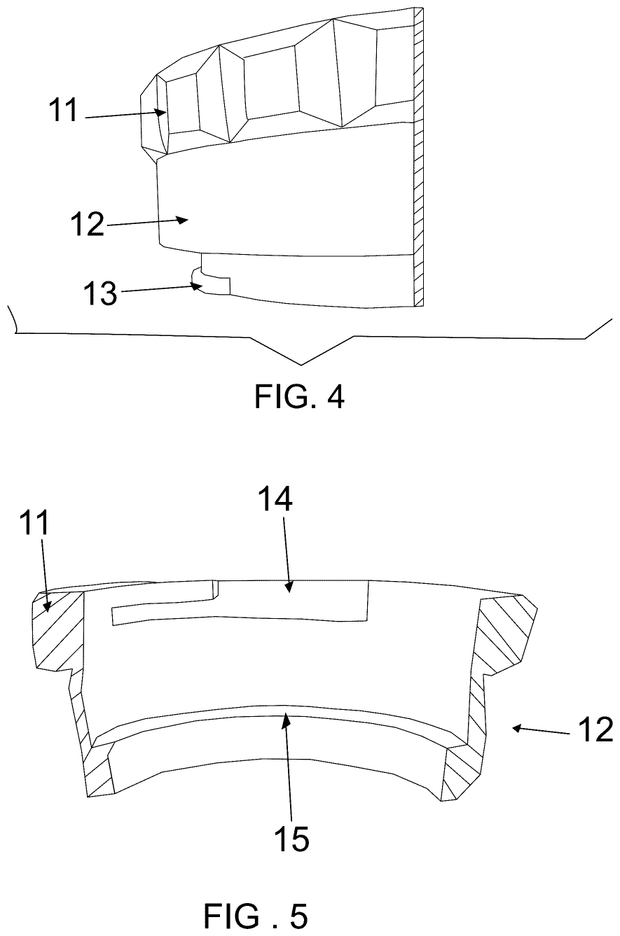

FIG. 6 depict the handled lid of the rhinestone size sorting system.

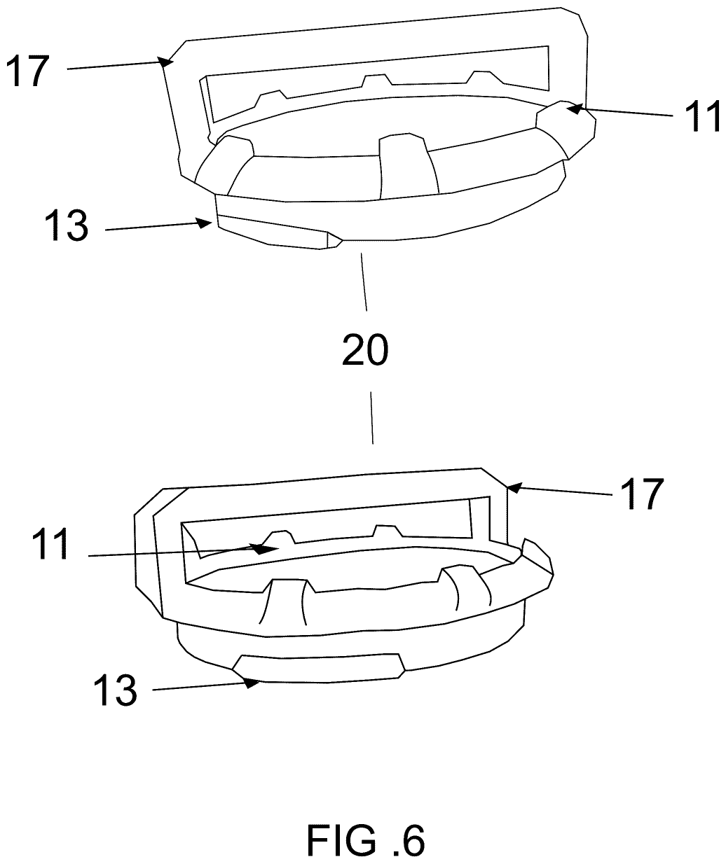

FIG. 7-8 depict the metal bottom and bevel of the rhinestone size sorting system

FIG. 9 depicts a horizontal cross-sectional view of line 12 of FIG. 1 of the rhinestone size sorting system.

### DETAILED DESCRIPTION

In the summary, the Detailed Description, the claims, and in the accompanying drawing, references made to flatback rhinestones featured in the invention it is to be understood that the disclosure of the invention and this specification includes all possible combinations flat back rhinestone features for example where a flat back rhinestone features is disclosed in the concept of a particular aspect or a body movement or the invention or particular claim that features may also be used to an extent possible in combination with and or in the context of other flat background stones aspects and embellishment of the invention and in the invention generally.

Where references made here in to a method comprising two or more steps that define steps may be carried out in any order or simultaneously (except where the content excludes that possibility) and the method may include one or more other steps which are carried out before any of the defined steps between two other defined steps and after all the defined steps (except where the context excludes the possibility)

The present disclosure recognizes the unsolved need for a rhinestone size sorting system to sort, separate and store flatback rhinestones of different material and sizes utilizing a multilevel system of compartments with permanent sieves at different levels. the system employs a combination of gravitational downward force and/or a motorized device applied by an operator on the system to automatically sort and organized flat back rhinestones of different sizes and material into the representing compartment. Each compartment and the compartment sieve are constructed so that particular sizes maybe filter downward to the next level resulting finally in a set of sorted flat back rhinestones at different levels within the system. The compartments also function as a storage structure for flat back rhinestones before during and after this sorting of the flat back rhinestones. whereby they may also be easily transported and move into another device.

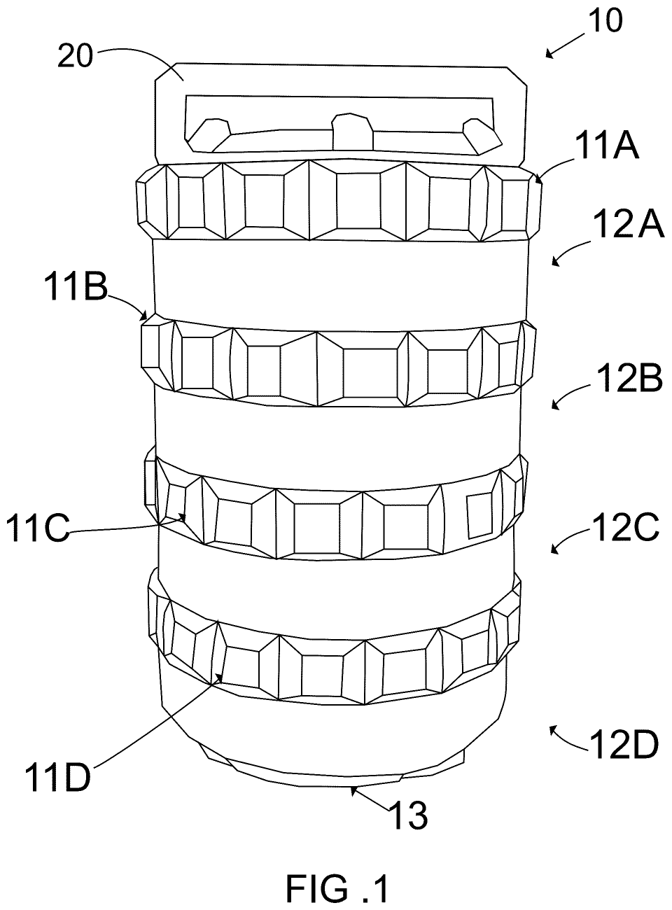

With reference now to FIG. 1, exemplary embodiment of the rhinestone size sorting system 10 is illustrated including compartment protruding upward from bottom compartment 12D. such as compartments 12A forming an opening on top. The opening maybe square, rectangular, circular, oval, triangle, trapezoid, octagon or hexagon in shape. Compartment 12A-12D May include a parallel angle thereby aiding the interlocking and separation of the multiplicity of compartments. Finger grip 11A-11D on the sorting compartment 12A-12D located at the top portion of compartments 12 assist the operator in opening said compartment. interlocking tabs 13 Used to promote tight connection of sorting compartments 12, handled lid with finger grips 20. Ensures the seal preventing flat back rhinestone from escaping the sorting compartment.

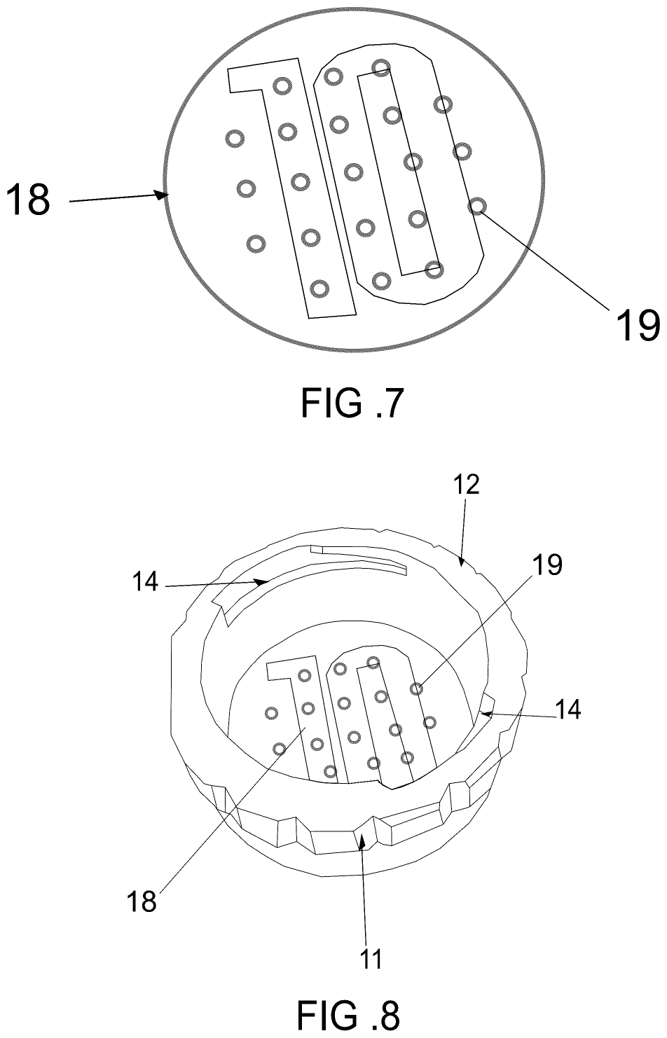

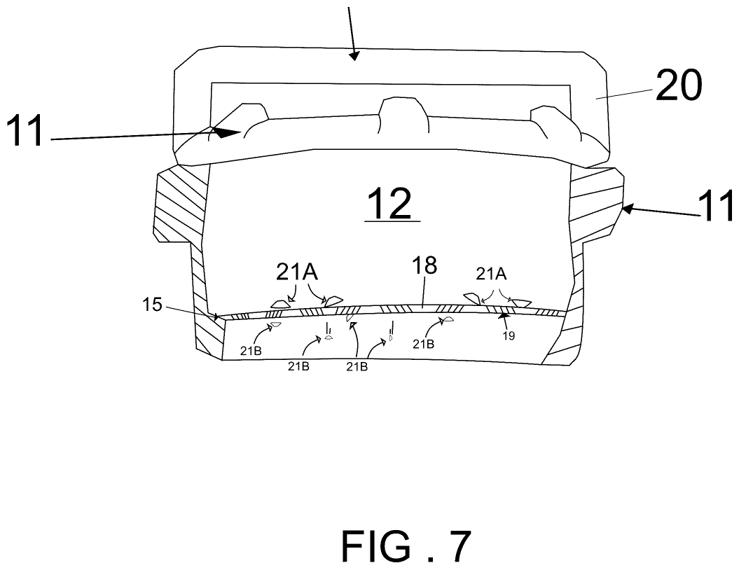

Interlocking grooves 14 on sorting compartment 12 to promote tight connection shown in FIGS. 1,4, 6. Bezel recess 15 to allow for the metal sieve 18 to be permanently secured into bezels recess 15 and be made of metal such as aluminum. Plastic, acrylic, wood or other materials that yield the designed size and mechanical strength can be utilized as well. Holes 19 are shown as circular in shape showing in FIGS. 7, 8, 9. These shapes and arrangements are selected to improve the speed and ease of filtering flatback rhinestones through the rhinestone size sorting system 10. In further embodiments as illustrated in FIG. 8, metal bottom is permanently attached to sorting compartment 12.

In one or more non-limiting embodiments an interlocking tab 13. Maybe located at the bottom of sorting compartments 12. In one or more non-limited embodiments an interlocking groove located on the top interior of sorting compartment 12. Finger grip notches 11 help with gripping of compartments 12. handled lid with finger grips 20 may be used as a cover during size sorting process such that an operator may provide a circular motion or shaking without the loss of the flat back rhinestones. containers 12 are preferably made of a polylactic acid material this however is non-limited any other materials such as metal, wood, cardboard, paper, fiberglass, glass, plastic and acrylic maybe use that may provide the necessary functions for sieving flat back rhinestones through the system.

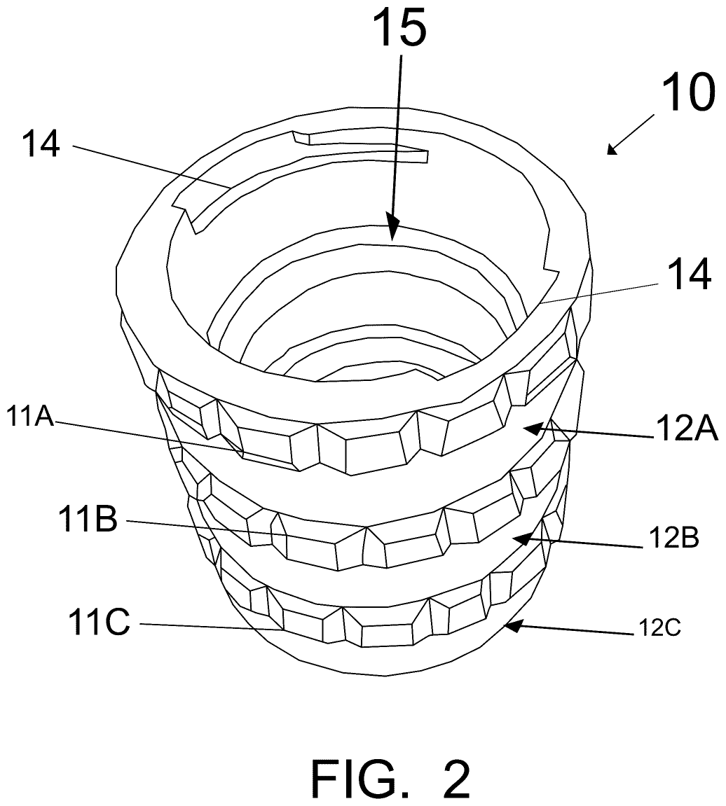

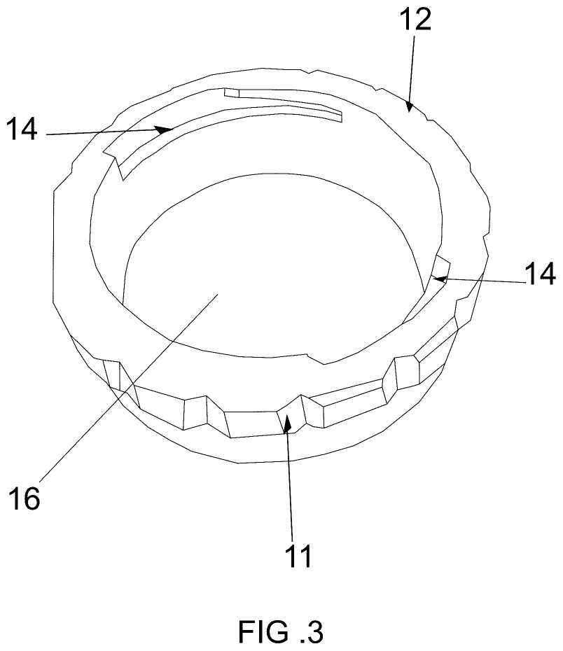

Bases 16 in FIG. 3. of the compartments 12 depicts a lack of circular holes. Whereby as compartments 12 may have bezel recessing as illustrated in FIG. 2, 5, 7. Bezel recesses 15 may be sized to permit a metal bottom 18 to be attached to the recess 15 located at the base of each compartment 12. Whereby metal bottom 18 may completely cover the opening in base 12 of each compartment. Except the lowest sorting compartment 12. To prevent the passage of substantially larger flat back rhinestones from passing through 12 sorting compartments. The metal bottom 18 is permanently attached to the sorting compartments 12 to form a seal that prevents flat back rhinestone from escaping or becoming lodged in the sorting compartments. 12.

One or more non-limited metal bottom 18 may be used. Metal bottom 18 designed to be permanent may be positioned to fit the individuals use and needs of the operator, openings 19 may be a series of circular holes in parallel or other formation. In other non-limiting embodiments metal bottoms, me be affixed to sorting compartment 12 with, for example adhesive, welding techniques, fastener, or any other method known to those skilled in the art wherein smaller flat back rhinestones that fit through the metal bottom 18 will not be trapped in the sorting compartments 12.

In one or more non-limited Compartments 12, compartments maybe stacked on top of each other utilizing an interlocking tab 13 and interlocking groove 14 configuration. The size of the holes in the metal bottom 18 in sorting container 12 are sized to allow certain sized flat back rhinestone to pass through while retaining larger sizes in the compartment until the smallest size flat back rhinestone are collected at the bottom sorting compartment. For example, the metal bottom 18 attached to the base of the sorting compartment 12 at the highest vertical level has the biggest circular holes measured in mm the holes have +/−0.2-+/−0.5 mm differential in size comparison to the flat back rhinestone it is capturing in that particular sorting compartment 12. The metal bottom attached to the bottom of sorting containers 12 has the biggest circular holes while the metal bottom directly below it has smaller circular holes than the metal bottom above. This continues until the bottom container deprived of any circular holes 16 collects the smallest flat back rhinestones within itself. Holes 19 may be of any size and maybe of any size distribution to meet customized needs of different types of flat back rhinestone. In one or more non-limiting embodiments, holes 19 in the metal bottom 18 of the sorting container 12 may be aligned while in other embodiments holes 18 in sorting compartments 12 in respect to each compartment. May be offset from one another. In one or more non-limited embodiments the bottom container may have a motorized motor to improve sieving while also enhancing the sorting of flat back rhinestones by capitalizing on the different vibrations applied from motorized device attachment to the rhinestone size sorting system.

The sieving process is carried out by inserting flat back rhinestone 21 in the top sorting compartment 12. Attaching the handled lid 20, and through manual force of shacking or motorized force using vibrations. The stacked interlocking compartments as illustrated in FIGS. 1, 7, forces the flat back rhinestones in each compartment 12 to move through the metal bottom 18 of each compartment and cause certain flat back rhinestone to fall through the metal bottom 18 utilizing the holes 19 enabling the sorting of the different sized flat back rhinestone. As the rhinestone size sorting system undergoes more shaking or vibration more flat back rhinestones are sorted until eventually all flat back rhinestones are sorted into their appropriate compartments. The smallest flat back rhinestone falls down into the bottom compartment depicted in FIG. 7. While the largest flat back rhinestone is retained in the higher compartment. The other compartments contain flat back rhinestones of specific size ranges depending on the size of the metal bottom 18. Depicted in FIG. 7.

For example, in the in-illustration FIG. 7, 8. in one or more non-limiting embodiment, the higher metal bottom may have a larger number or circular holes 19 in pertaining to that sorting compartment, whereby the next sorting compartment below will have a smaller number depicted as well as smaller metal bottom holes 19 allowing flat back rhinestones to pass through to the bottom sorting container 12 depicted with not holes 16 In FIG. 3.

In one or more non-limiting embodiments the top most compartments 12 may have a handled lid 20, as illustrated in FIGS. 1, 7. Sealing of the top sorting compartments 12 shuts and preventing flat back rhinestones from escaping. The handled lid 20 may have a finger grip 11 to assist the operator with opening the sorting compartment 12. In one or more non-limited embodiments the handled lid is attached to the sorting compartment 12 using an interlocking tab 13 into an interlocking groove 14 firmly securing the handled lid to the sorting compartment 12 creating a substantially tight seal that prevents the escaping of flat back rhinestones from the sorting compartments 12. The lid may be removed by applying a twist method to disengage the interlocking tab 13 from the interlocking groove 14.

The foregoing description of the invention has been presented for purposes of illustration and description and is not intended to be exhaustive or to limit the invention to the precise form disclosed. any modifications and variations are possible in light of the above teaching. The embodiments were chosen and described to best explain the principles of the invention and its practical application to thereby enable other skills in the art to best use invention in various embellishments and with various modifications suited to the use of contemplated. the scope of the invention is to be defined by the above claim.

What is claimed is:

1. A system of sieving different sizes flat back rhinestones, comprising:
a multiplicity of compartments, arranged to house a portion of flat back rhinestone, each sorting compartment include but not limited to sidewalls that are parallel including but not limited to finger grips protruding upwards from a base, a sieve bottom included but not limited to any particular material, defined with a majority of holes, each of the multiplicity of compartments including but are not limited to a bezel surface slightly depressed from the surface on the base of a compartment wherein a sieve included but not limited to metal resting on the depressed surface such that the sieve is parallel with the surface of the base;
An opening on the top of the system allowing flat back rhinestones to be introduced into the system; and
A bottom compartment consisting a base, barren of holes as to collect flat back rhinestones that proceed through the opening in the multiplicity of compartments directing over the last compartment;
Each compartment constructed for separating flat back rhinestones by moving the compartments in a circular and/or shaking motion included but not limited to a motorized device attached to, on, or in the system, that will allow flat back rhinestones to proceed through the majority of holes located in the base of the compartment into the next compartment allowing only the largest of the flat back rhinestone to stay in the compartment previous.

2. The system of claim 1, the compartments are located on top of another to form a vertically stacked display includes but not limited to an interlocking system.

3. The system of claim 1, wherein the compartments are made of but are not limited to polylactic acid material.

4. The system of claim 1, wherein the compartments include but are not limited to stacking, interlocking tabs and or circular connection.

5. The system of claim 1, wherein the compartments include but are not limited to Finger grips on individual compartments.

6. The system of claim 1, wherein the system consists a lid and or top that is included but not limited to a handle.

7. The system of claim 1, the holes located in the bottom of each compartment, not including the base, includes but are not limited to uniformly spaces over the sieve bottom that is included but not limited to a metal material.

8. The system of claim 7, wherein the holes are circular forming a grid included but not limited to a uniformly spacing over the base pf each compartment not including the bottom base

9. The system of claim 1, wherein the sidewalls are parallel extruding from a base.

10. The system of claim 1, the sieve bottom that includes but is not limited to being held in the bezel surface by a material included but not limited to cyanoacrylate that will secure the sieve base to the sorting system from being removed.

11. The system of claim 1, wherein the compartment includes but is not limited to an interlocking tab and groove.

12. A system of sieving different sizes flat back rhinestones, comprising:
A multiplicity of compartments, designed as a reservoir to keep a quantity of flat back rhinestones, each compartment consist of parallel walls extruding upward from a base, a metal sieve, the metal sieve consisting of multiple holes, the bottom of the compartment including a bezel edge, the bezel edge to receive the metal sieve.
An opening at the top of the system provided to allow flat back rhinestones to be introduced into the system.
A base compartment, the base compartment designed to not include any opening so as to collect flat back rhinestones that has passed through the opening in the previous compartments, the bottom compartment including but not limited to finger grips and an interlocking tongue and groove or circular connection to connect the previous compartments.
Each compartment designed for sifting flat back rhinestones by moving the compartments in a circular and or shaking motion or with assistance from a motorized device located in, on, or attached to thereby allowing flat back rhinestones to pass through the circular holes located at the bottom of the compartments, which allows the larger compartments to hold larger flat back rhinestones allowing smaller ones to pass through to the lower compartment below.
Wherein the metal sieve and the bezel recess are in contact with one another forming a seal preventing flat back rhinestones from escaping out the sides or becoming lodged utilizing the openings to allow flat back rhinestone to pass through.

13. The system in claim 12, wherein the metal sieve of each compartment is designed to permanently attached to the compartment.

14. The system in claim 12, wherein the compartments are stacked and or interlocked one on top of another in a vertically stacking display or tower

15. The system in claim 12, wherein the compartments are made of but are not limited to polylactic acid, wood, plastic, acrylic, and metal.

16. The system in claim 12, further comprises of ridges located at the top of each compartment, included but not limited to assisting the user as a grip or a finger grip to assist the user in separating interlocking compartments.

17. The system in claim 12, wherein the sieve bottom is made of metal, wood, acrylic, plastic, and polylactic acid.
